(19) United States
(12) Patent Application Publication
(10) Pub. No.: US 2024/0056187 A1
(43) Pub. Date: Feb. 15, 2024

(54) HYBRID INTERNET DISTRIBUTION SYSTEM

(71) Applicant: Outer Reach Broadband LLC, Hallowell, ME (US)

(72) Inventors: Thomas Kirby, Falmouth, ME (US); James Harding, Washington, ME (US)

(73) Assignee: Outer Reach Broadband LLC, Hallowell, ME (US)

(21) Appl. No.: 18/232,467

(22) Filed: Aug. 10, 2023

Related U.S. Application Data
(60) Provisional application No. 63/397,175, filed on Aug. 11, 2022.

(51) Int. Cl. H04B 10/2575

(52) U.S. Cl. CPC H04B 10/25753

(57) ABSTRACT

A hybrid system and method to provide reliable and cost-effective high speed broadband internet to rural or geographically dispersed areas. Areas with existing telecommunication towers and favorable topography are targeted with a broadband network using fixed wireless radio technology (aka “RF” or radiofrequency radiation), covering upwards of 50 to 80 percent of the area with high-speed, reliable broadband connectivity, and supplementing that fixed wireless coverage with “FTTP neighborhoods” (FTTP—fiber to the premises) to bring community coverage to 100 percent.

### CROSS-REFERENCE TO RELATED APPLICATIONS

This application claims priority from U.S. Provisional Patent application No. 63/397,175 filed Aug. 11, 2022 titled HYBRID INTERNET DISTRIBUTION SYSTEM, which application is fully incorporated herein by reference.

### TECHNICAL FIELD

The present invention relates to broadband internet service and more particularly, to a hybrid internet distribution system which combines wireless radio technology with fiberoptic technology to deploy internet to rural areas.

### BACKGROUND INFORMATION

Much of the United States lacks accessibility to reasonably priced and reliable broadband internet service. Part of the challenge in providing broadband internet service to large geographically dispersed areas without a significant concentration of residences or businesses is that these home or businesses are typically spread out away from town centers and fiber hubs.

Although wireless radio frequency (RF) technology works well in providing reliable broadband internet service if there is a line-of-sight between a home or business and a radio tower, this is not always the case particularly in areas that are mountainous or heavily treed. Mountains and trees generally block RF wireless signals and thereby preclude the use of radio frequency wireless technology to deploy broadband internet in such areas.

On the other hand, because homes and businesses in rural areas are indeed spread out away from town centers and/or fiberoptic hubs, deploying wires (cable or fiberoptic) to homes or businesses in rural areas from a hub in a town center or the like is cost prohibitive.

Accordingly, what is needed is a system and method to provide high-speed and reliable broadband internet to rural areas utilizing the combination of both radio frequency deployment of broadband internet in and to those areas that lend themselves to this technology, while then providing point-to-point broadband internet to homes and businesses that are more dispersed utilizing fiberoptic

### SUMMARY OF THE INVENTION

The invention features a hybrid system and method to provide reliable and cost-effective broadband internet to rural or geographically dispersed areas. The invention proposes targeting areas with existing telecommunication towers and favorable topography with a broadband network using fixed wireless radio technology (aka “RF” or radio frequency radiation), covering upwards of 50 to 80 percent of the area with high-speed, reliable broadband connectivity, and supplementing that fixed wireless coverage with “FTTP neighborhoods” (FTTP—fiber to the premises) to bring community coverage to 100 percent.

Part of the challenge in connecting the FTTP neighborhoods is that they are often spread out away from town centers and fiber hubs. The present invention contemplates serving those neighborhoods with new fiber construction or by using point-to-point radio technology to provide backhaul from an existing tower. The invention proposes covering one contiguous geographic area with multiple forms of “last mile” broadband connectivity (FTTP and radio/RF/fixed wireless). The different last mile delivery technologies will be brought together in one central aggregation point and then service will be passed to a core network hub in a data center.

The goal of the present invention is 100% coverage and acknowledges the limitations of RF technology and proposes to supplement the radio technology with FTTP in areas that RF cannot reach. Further, with FTTP neighborhoods built to fill-in the holes in RF coverage across a target area in the first implementation of the topography disclosed in this invention will be a true foundation laid for community-wide FTTP in the longer-term (i.e. by expanding/connecting the original FTTP neighborhoods) to more and more fiber as time and money permits.

### BRIEF DESCRIPTION OF THE DRAWINGS

These and other features and advantages of the present invention will be better understood by reading the following detailed description, taken together with the drawings wherein:

FIG. 1A is a block diagram of the processing and internet and world wide web connectivity of the local deployed hybrid internet structure show in in FIG. 1B according to the present invention; and

FIG. 1B is a block diagram of the local hybrid deployment according to one embodiment of the present invention.

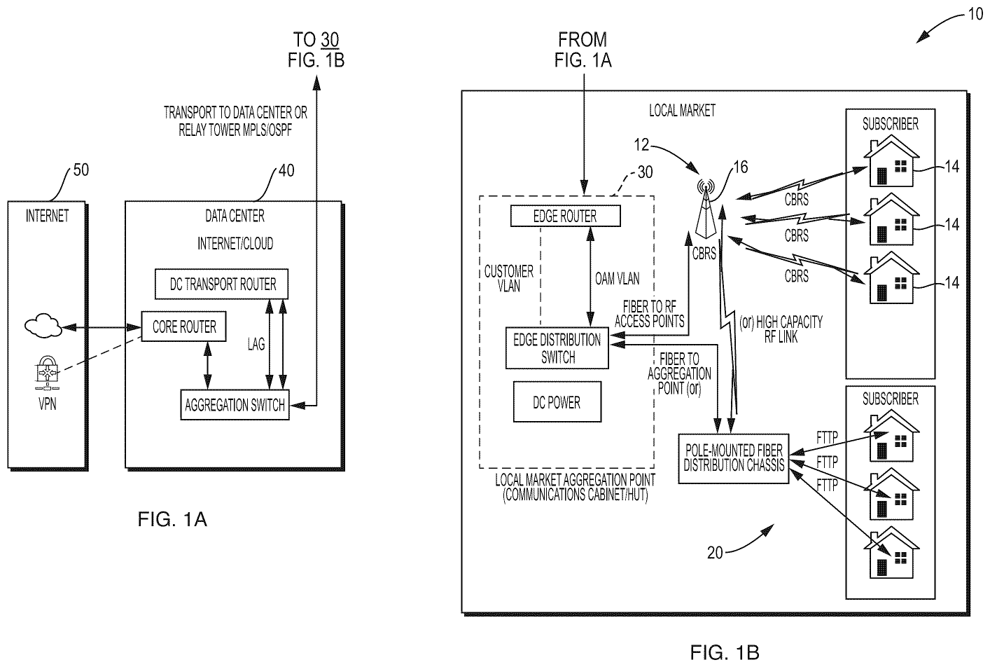

### DETAILED DESCRIPTION OF THE PREFERRED EMBODIMENTS

The present invention features a hybrid broadband internet deployment topography and implementation. The deployment begins with RF coverage 12 to those subscribers 14 that can receive the RF wireless signal from one or more towers 16. The wireless portion 12 of the hybrid network can be deployed and be up and running within a few months at a reasonable cost. An exemplary RF technology is available from Tarana company.

Part of the challenge in connecting the FTTP neighborhoods 20 is that they are often spread out away from town centers and fiber hubs. The present invention is intended and designed to serve those neighborhoods with new fiber construction or by using point-to-point radio technology 12 to provide backhaul from an existing tower 16. The present invention is proposing to cover one contiguous geographic area with multiple forms of “last mile” broadband connectivity (FTTP 20 and radio/RF/fixed wireless 12). The different last mile delivery technologies will be brought together in one central aggregation point 30 and then service will be passed to a core network hub 40 in a data center for connection to and from the internet 50.

Although community-wide FTTP topography 20 is excellent and will provide long-term benefits to communities, make-ready preparations, network planning, equipment lead times and construction availability means such community wide deployment of FTTP topography and technology will take YEARS for residents to experience any change in their daily lives. The present invention, however, will bring tangible benefits to a meaningful percentage of the population within a relatively short period of time (four to six months perhaps depending on equipment availability.

The present invention acknowledges the limitations of RF wireless technology and proposes to supplement the radio technology with FTTP in areas that RF cannot reach. Further, with FTTP neighborhoods built to fill-in the holes in RF coverage across a target area in a relatively short period of time, there will be a true foundation laid for community-wide FTTP in the longer-term (i.e. by expanding/connecting the original FTTP neighborhoods to a central FTTP infrastructure.

Equipment Replacement Cycle: fixed wireless equipment is assumed to have five-to-seven-year life cycle. As the equipment gets closer to replacement, it will be crucial to assess (1) take-rates (the number of subscribers signing up for the service) in RF coverage areas and (2) the latest generation of fixed wireless technology which may or may not be more attractive than investing in FTTP.

Take-rates: if specific coverage areas experience significantly higher than expected take-rates (a specific threshold to be determined) those areas will be natural targets for FTTP investment.

Financial Flexibility: by reducing the cost of the initial network build by 50 to 70 percent as compared to a community-wide FTTP build from Day 1, financial flexibility is built into the network's future growth.

In summary, the present invention seeks to target communities with a plan to provide short-term coverage with RF radio technology and covering all other areas the RF technology misses with FTTP. As detailed in the points above, the plan is highly flexible from both operational and financial perspectives. The key to that flexibility is reducing the necessary upfront investment in FTTP which will drive down upfront costs and reduce the time spent waiting for better connectivity. Future financial flexibility also comes as a result of proving the community's take-rate over the life cycle of the radio technology.

When it is time to consider replacing the radio technology the financial feasibility of the area will be known in much more detail as there will have been a high-speed network operating in the area for multiple years. As we look at this with other involved parties (strategic, operational, community etc.) this invention has multiple natural benefits for both the target area and the internet service provider.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

The invention claimed is:

1. A hybrid system and method to provide reliable and cost-effective high speed broadband internet to rural or geographically dispersed areas, said system comprising;
a data center, coupled to the world wide web, and configured for receiving and transmitting data to and from a plurality of subscribers and said worldwide web;
a plurality of radio frequency access points, coupled to said data center, configured for transmitting and receiving data by means of radio frequency, and wherein a first group of said plurality of subscribers are coupled said plurality of radio frequency access points, for providing broadband internet to and from said first group of subscribers via said world wide web; and
a plurality of fiberoptic distribution devices, coupled to said data center, each of said plurality of fiberoptic distribution devices coupled to a second group of said plurality of subscribers, for providing broadband internet to and from said second group of subscribers via said world wide web.
